(19) United States
(12) Patent Application Publication
(10) Pub. No.: US 2015/0170379 A1
(43) Pub. Date: Jun. 18, 2015

(54) APPARATUS AND METHOD FOR MEASURING THREE-DIMENSIONAL (3D) SHAPE OF OBJECT BY USING LIQUID

(71) Applicant: Electronics and Telecommunications Research Institute, Daejoen (KR)

(72) Inventors: Seong Ho SON, Daejeon (KR); Hyuk Je KIM, Daejeon (KR); Jong Moon LEE, Cheongju-si (KR); Soon Ik JEON, Daejeon (KR)

(21) Appl. No.: 14/488,685

(22) Filed: Sep. 17, 2014

(30) Foreign Application Priority Data
Dec. 17, 2013 (KR) 10-2013-0157458

(51) Int. Cl. G06T 7/60; G06T 15/00

(52) U.S. Cl. CPC G06T 7/602; G06T 15/00; G06T 2207/10072; G06T 2210/41; G06T 2207/30068

(57) ABSTRACT

An apparatus and method for measuring a three-dimensional (3D) shape of an object using a liquid is provided, the method including generating an image by photographing an object immersed in a liquid, extracting a section contour indicating a boundary between the object and a surface of the liquid from the image, and measuring a 3D shape of the object using the extracted section contour.

### CROSS-REFERENCE TO RELATED APPLICATION

This application claims the priority benefit of Korean Patent Application No. 10-2013-0157458, filed on Dec. 17, 2013, in the Korean Intellectual Property Office, the disclosure of which is incorporated herein by reference.

### BACKGROUND

1. Field of the Invention

The present invention relates to an apparatus and method for measuring a three-dimensional (3D) shape of an object using a liquid, and more particularly, to an apparatus and method for measuring a 3D shape of an object using a boundary between a surface of water naturally created in a liquid and a breast.

2. Description of the Related Art

In recent times, research into microwave tomography (MT) using an electromagnetic wave is being conducted to develop a new technology for diagnosing breast cancer.

An existing apparatus for generating a tomographic image may immerse a breast in a predetermined matching solution that allows an electromagnetic wave to readily penetrate the breast, and reconfigure a tomographic image of the breast based on wave scattering data that penetrates the breast.

When a three-dimensional (3D) shape of the breasts is acquired, a speed of reconfiguring the tomographic image and a quality of the tomographic image may be enhanced using the acquired information. However, accurately measuring a shape of an object immersed in a liquid from outside may be challenging because a light penetrating the liquid such as a matching solution may have an issue of being refracted or reflected.

Accordingly, there is a need for a method of accurately measuring a 3D shape of an object immersed in a matching solution.

### SUMMARY

An aspect of the present invention provides an apparatus and method for measuring a three-dimensional (3D) shape of an object absent an additional optical marking device, for example, a laser, by identifying a boundary between a surface naturally created on a liquid and a breast, extracting a section contour from the identified boundary, and reconstructing a 3D shape of an object using the extracted section contour.

According to an aspect of the present invention, there is provided a method of measuring a 3D shape, the method including generating an image by photographing an object immersed in a liquid, extracting, from the image, a section contour indicating a boundary between the object and a surface of the liquid, and measuring a 3D shape of the object using the extracted section contour.

The measuring may include measuring the 3D shape of the object by converting pixel coordinates of the section contour to absolute space coordinates.

The generating may include increasing a contrast between an area of the object immersed in the liquid and an area not immersed in the liquid by controlling intensity of a light source that outputs a light to the liquid.

The generating may include photographing the object immersed in the liquid using a camera provided based on a critical angle of the liquid.

According to an aspect of the present invention, there is provided a method of measuring a 3D shape, the method including changing a boundary between an object and a surface of a liquid by controlling a plurality of surface heights of the liquid in which the object is immersed, extracting a section contour for the plurality of surface heights by photographing the object immersed in the liquid for the plurality of surface heights of the liquid, and measuring a 3D shape of the object using the section contour for the plurality of surface heights, wherein the section contour indicates the boundary between the object and the surface of the liquid.

The measuring may include reconstructing the 3D shape of the object by performing interpolation on the section contour for the plurality of surface heights.

According to an aspect of the present invention, there is provided an apparatus for measuring a 3D shape, the apparatus including an object photographing unit to generate an image by photographing an object immersed in a liquid, a section contour extractor to extract, from the image, a section contour indicating a boundary between the object and a surface of the liquid, and a 3D shape reconstructor to measure the 3D shape of the object by reconstructing the 3D shape of the object using the extracted section contour.

According to an aspect of the present invention, there is provided an apparatus for measuring a 3D shape, the apparatus including a controller to change a boundary between an object and a surface of a liquid in which the object is immersed by controlling a plurality of surface heights of the liquid, a section contour extractor to extract a section contour for the plurality of surface heights from an image obtained by photographing the object for the plurality of surface heights of the liquid, and a 3D shape reconstructor to measure a 3D shape of the object by reconstructing the 3D shape of the object using the section contour for the plurality of surface heights.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an apparatus for measuring a three-dimensional (3D) shape according to an embodiment of the present invention;

FIG. 2 is a diagram illustrating an example of an apparatus for measuring a 3D shape according to an embodiment of the present invention;

FIG. 3 is a diagram illustrating an example of an image generated by an apparatus for measuring a 3D shape photographing an object according to an embodiment of the present invention;

FIG. 4 is a diagram illustrating an example in which an apparatus for measuring a 3D shape extracts a section contour based on a surface height according to an embodiment of the present invention;

FIG. 5 is a diagram illustrating an example in which an apparatus for measuring a 3D shape reconstructs a 3D shape of an object using extracted section contours according to an embodiment of the present invention;

FIG. 6 is a diagram illustrating a first example of an apparatus for measuring a 3D shape according to an embodiment of the present invention;

FIG. 7 is a diagram illustrating a second example of an apparatus for measuring a 3D shape according to an embodiment of the present invention; and

FIG. 8 is a flowchart illustrating a method of measuring a 3D shape according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures. A method of measuring a three-dimensional (3D) shape according to an embodiment of the present invention may be performed by an apparatus for measuring a 3D shape.

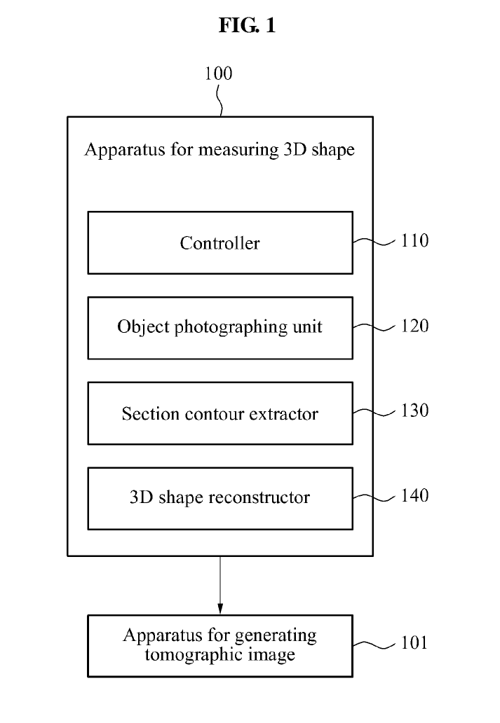

FIG. 1 is a block diagram illustrating an apparatus 100 for measuring a 3D shape according to an embodiment of the present invention.

An apparatus 101 for generating a tomographic image generates a tomographic image of an object immersed in a liquid using an electromagnetic wave. For example, the term “object” may refer to a target object to be measured to generate the tomographic image, including such as an object to be immersed in a liquid or a portion of a user body, for example, breasts. The term “liquid” may refer to a matching solution that enables the electromagnetic wave to readily penetrate an interior of the breasts.

In one example, the apparatus 101 for generating the tomographic image outputs an electromagnetic wave to an object immersed in a liquid, receives an electromagnetic wave that penetrates the object, and generates the tomographic image of the object based on a difference between the received electromagnetic wave and the output electromagnetic wave. In this example, when the apparatus 101 for generating the tomographic image is aware of a 3D shape of the object, the electromagnetic wave that penetrates the object is identified based on the 3D shape of the object, the tomographic image is generated using the electromagnetic wave that penetrates the object, and a speed and accuracy of generating the tomographic image are enhanced.

The apparatus 100 for measuring the 3D shape may enable the apparatus 101 for generating the tomographic image to enhance a speed and accuracy of generating the tomographic image by measuring the 3D shape of the object immersed in the liquid, and providing a result of the measurement to the apparatus 101 for generating the tomographic image.

Referring to FIG. 1, the apparatus 100 for measuring the 3D shape includes a controller 110, an object photographing unit 120, a section contour extractor 130, and a 3D shape reconstructor 140.

The controller 110 controls a surface height of the liquid in which the object is immersed. Here, a shape and a cross section area size of a boundary between the object and a surface of the liquid may vary based on the surface height changed by the controller 110.

For example, the controller 110 may allow the object not to contact the liquid prior to being fixed onto the apparatus 101 for generating the tomographic image by lowering, to a minimum, the surface height of the liquid used by the apparatus 101 for generating the tomographic image.

When the object is fixed onto the apparatus 101 for generating the tomographic image, the controller 110 may raise the surface height of the liquid.

When the liquid of which the surface height is raised by the controller 110 contacts the object and the boundary between the object and the surface of the liquid is formed, the object photographing unit 120 generates an image by photographing the object immersed in the liquid using a camera.

In this example, the controller 110 enables the object photographing unit 120 to photograph the object without trembling caused by a change in the surface height of the liquid by fixing the surface height of the liquid at predetermined intervals during a process of raising the surface height of the liquid. The controller 110 raises the surface height of the liquid at a speed at which the surface or the interior liquid does not shake, and the object photographing unit 120 photographs the object successively.

The object photographing unit 120 enhances a contrast between an area of the object immersed in the liquid and an area not immersed in the liquid by controlling intensity of a light source that outputs a light to the liquid. When the contrast between the area of the object immersed in the liquid and the area not immersed in the liquid is high, the boundary between the object and the surface of the liquid is clearly displayed in the image.

The object photographing unit 120 photographs the object immersed in the liquid using a camera provided based on a critical angle of the liquid.

When a viewing angle of the camera corresponds to the critical angle of the liquid, a total reflection may occur on the surface, and the object disposed on the surface may not be displayed in the image. Accordingly, the boundary between the object and the surface of the liquid is clearly displayed in the image photographed by the camera because only the surface and the area of the object immersed in the liquid are displayed in the image.

The section contour extractor 130 extracts a section contour that indicates the boundary between the object and the surface of the liquid from the image generated by the object photographing unit 120.

Here, the section contour extractor 130 extracts the section contour for a plurality of surface heights by photographing the object immersed in the liquid for the plurality of surface heights of the liquid changed by the controller 110.

The 3D shape reconstructor 140 measures a 3D shape of the object using the section contour extracted by the section contour extractor 130.

The 3D shape reconstructor 140 measures the 3D shape of the object by converting pixel coordinates of the section contour to absolute space coordinates. For example, the 3D shape reconstructor 140 converts pixel coordinates, for example, (u, v) of the section contour to absolute space coordinates, for example, (x, y, z) using an optical triangulation technique. The 3D shape reconstructor 140 performs underwater distortion compensation on the section contour.

The 3D shape reconstructor 140 measures the 3D shape of the object using the section contour for the plurality of surface heights.

For example, the 3D shape reconstructor 140 reconstructs the 3D shape of the object by performing interpolation on the section contour based on the plurality of surface heights, and measures the 3D shape of the object using the reconstructed 3D shape.

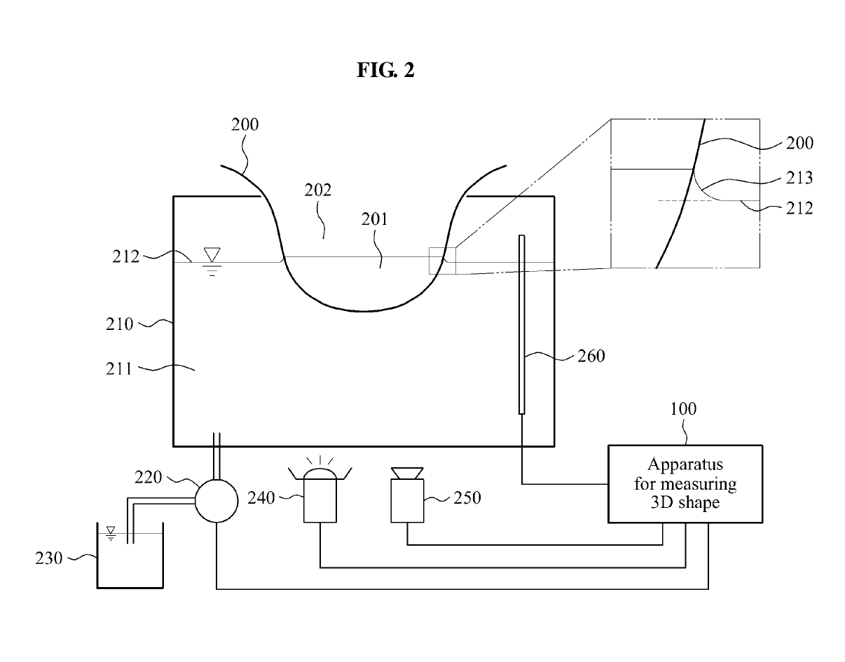

FIG. 2 is a diagram illustrating an example of the apparatus 100 for measuring the 3D shape according to an embodiment of the present invention.

Referring to FIG. 2, the apparatus 100 for measuring the 3D shape includes a pump 220, a lighting 240, a camera 250, and a water surface sensor 260.

The pump 220 lowers a surface height of a liquid 211 contained in a main water tank 210 by moving the liquid 211 in the main water tank 210 to an auxiliary water tank 230 based on control by the controller 110. The pump 220 raises the surface height of the liquid 211 contained in the auxiliary water tank 230 by moving the liquid 211 in the auxiliary water tank 230 to the main water tank 210 based on control by the controller 110.

The lighting 240 brightens an interior of the main water tank 210 based on control by the controller 110. Here, the lighting 240 may be disposed internally or externally with respect to the main water tank 210. For example, the lighting 240 is disposed at a position at which a light is provided to allow an area 201 of an object 200 to be viewed more clearly than an area 202 of the object 200 in an image generated by the camera 250 photographing the object 200.

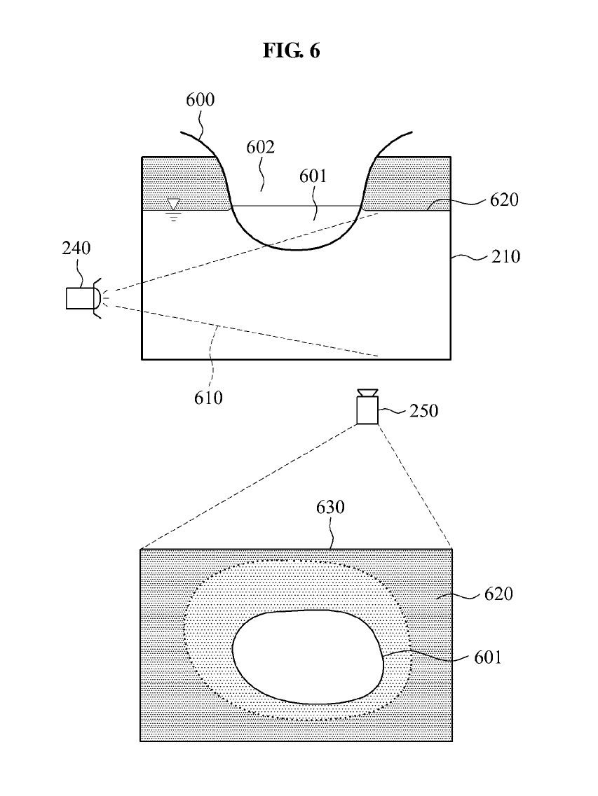

The disposition of the lighting 240 will be discussed later with reference to FIG. 6.

The camera 250 photographs the area 201 of the object 200 immersed in the liquid 211 based on control by the object photographing unit 120 of the apparatus 100 for measuring the 3D shape. In this example, the camera 250 is disposed at one position from among underneath the main water tank 210, a side of the main water tank 210, and inside the liquid 211 of the main water tank 210. By way of example, the camera 250 is provided based on a critical angle of a liquid when photographing the object 200.

The water surface sensor 260 detects a surface height of the liquid 211 contained in the main water tank 210, and transfers the detected surface height to the controller 110. In this example, the controller 110 controls the surface height of the liquid 211 by controlling the pump 220 based on the surface height detected by the water surface sensor 260.

The section contour extractor 130 of the apparatus 100 for measuring the 3D shape extracts a section contour of the object 200 formed by a boundary 213 between the object 200 and a surface 212 of the liquid 211 from an image generated through being photographed by the camera 250.

The 3D shape reconstructor 140 of the apparatus 100 for measuring the 3D shape reconstructs a 3D shape of the object 200 using the extracted section contour. In this example, the 3D shape reconstructor 140 reconstructs the 3D shape of the object 200 by performing interpolation on information about the section contour extracted for a plurality of surface heights of the liquid 211.

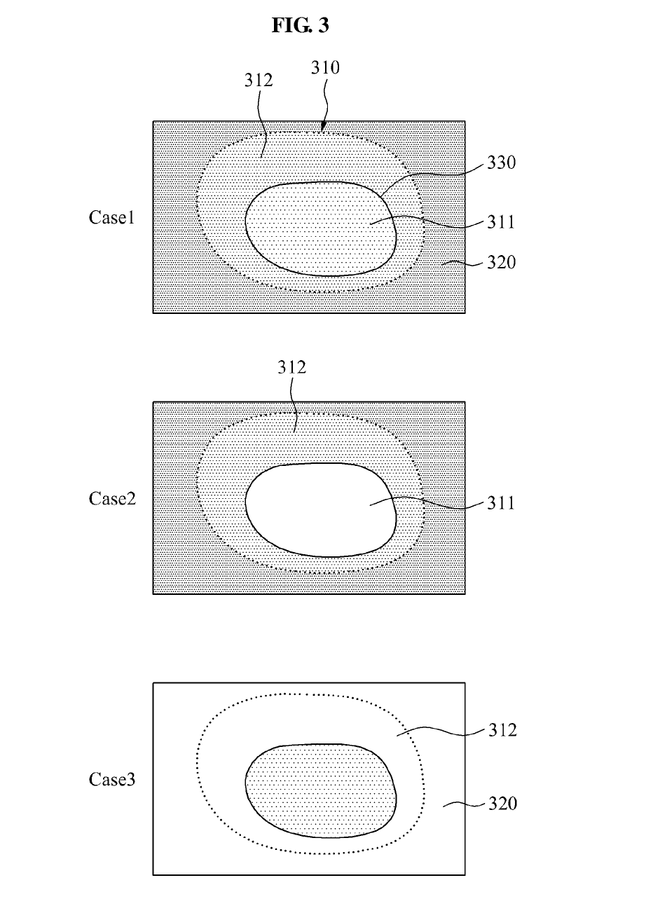

FIG. 3 is a diagram illustrating an example of an image generated by an apparatus for measuring a 3D shape photographing an object according to an embodiment of the present invention.

Case 1 in FIG. 3 illustrates an example of an image generated by the camera 250 disposed underneath the main water tank 210 of FIG. 2 photographing an object 310. In this example, the object 310 included in the image includes a boundary 330 generated by a surface tension of a surface 320 of the liquid 211.

Referring to FIG. 3, the object 310 is divided, by the boundary 330, into an area 311 immersed in the liquid 211 and an area 312 not immersed in the liquid 211. In this example, the area 312 is an area above the surface 320 from a viewpoint of the camera 250. Accordingly, the area 312 is photographed to be darker or dimmer than the area 311 based on conditions such as reflection or trembling of the surface. The section contour extractor 130 extracts a section contour by identifying the boundary 330 from the image.

Case 2 in FIG. 3 illustrates an example of an image generated by the camera 250 photographing the object 310 in a state in which the interior of the main water tank 210 is brightened by the lighting 240. In this example, the area 311 is brighter than the area 312 that receives a light of which a quantity of light is reduced by passing through the surface 320 because the area 311 receives a light output directly from the lighting 240.

Accordingly, a contrast between the area 311 and the area 312 may increase. When the contrast between the area 311 and the area 312 increases, the boundary 330 is clearer as shown in Case 2, allowing the section contour extractor 130 to readily identify the boundary 330 and extract a section contour.

In this example, the lighting 240 outputs a light at an angle so as to be totally reflected on a surface, and enables the light to brighten a portion containing the liquid 211 in the main water tank 210. As a result, the contrast between the area 311 and the area 312 increases to a greater extent, allowing the section contour extractor 130 to more readily identify the boundary 330.

Case 3 in FIG. 3 illustrates an example of an image generated by the camera 250 provided based on a critical angle of a liquid photographing the object 310. In this example, a total reflection may occur on the surface 320 and the area 312 on the surface may not be photographed by the camera 250. Accordingly, the section contour extractor 130 may readily identify the boundary 330 between the area 311 and the surface 320 because an image photographed by the camera 250 includes the area 311 of the object 310 and the surface 320.

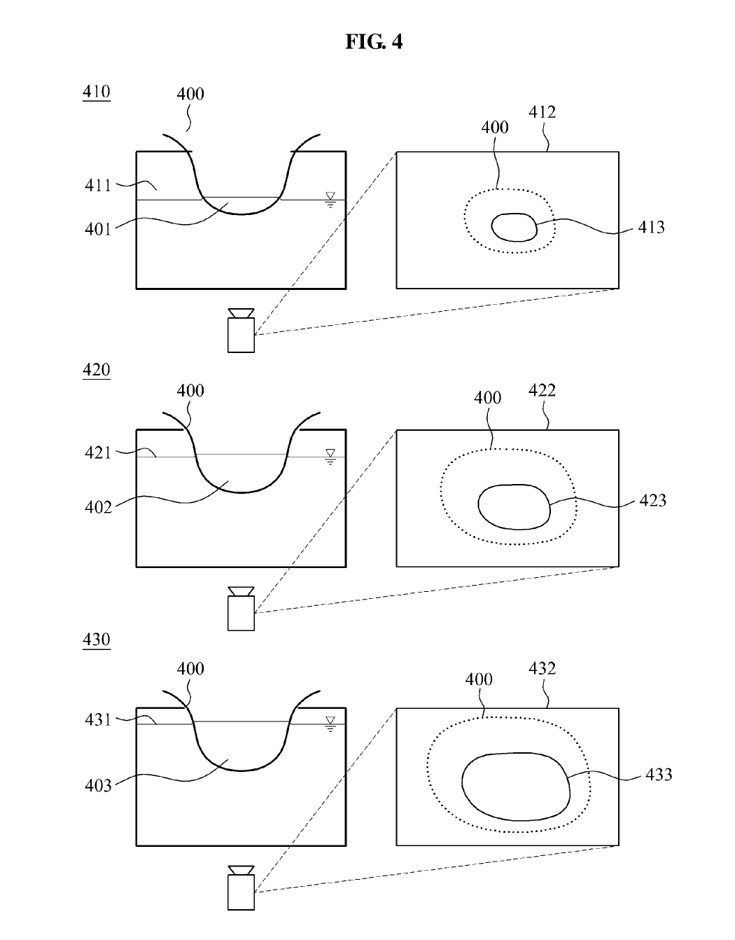

FIG. 4 is a diagram illustrating an example in which an apparatus for measuring a 3D shape extracts a section contour based on a surface height according to an embodiment of the present invention.

In operation 410, the controller 110 raises a surface height of a liquid initialized to a minimum height. When the liquid of which the surface height is raised by the controller 110 contacts an object 400, and a boundary between the object 400 and a surface 411 of the liquid is formed as shown in FIG. 4, the object photographing unit 120 generates an image 412 by photographing the object 400 immersed in the liquid using a camera. In this example, an area 401 immersed in the liquid is relatively narrow as shown in FIG. 4, and correspondingly, a section contour 413 extracted from a boundary between the object 400 and the surface 411 is also relatively narrow.

In operation 420, the controller 110 raises the surface height of the liquid higher than the surface height in operation 410. The object photographing unit 120 generates an image 422 by photographing the object 400 immersed in the liquid based on the surface height of the liquid using the camera. In this example, an area 402 immersed in the liquid of the object 400 refers to a breast having a narrower base and a wider top than the area 401 in operation 410 as shown in FIG. 4, and correspondingly, a section contour 423 extracted from a boundary between the object 400 and a surface 421 is also wider than the section contour 413 extracted in operation 410.

In operation 430, the controller 110 raises the surface height of the liquid to a maximum height of a water tank. The object photographing unit 120 generates an image 432 by photographing the object 400 immersed in the liquid to the maximum height of the water tank using the camera. In this example, an area 403 immersed in the liquid of the object 400 is wider than the area 401 in operation 410 and the area 402 in operation 420 as shown in FIG. 4, and correspondingly, a section contour 433 extracted between the object 400 and the surface 431 is also wider than the section contour 413 and the section contour 423.

In this sense, the apparatus for measuring the 3D shape adjusts the surface height of the liquid and extracts a section contour based on the surface height, thus identifying a size and a form of a cross section area for a plurality of heights of the object 400.

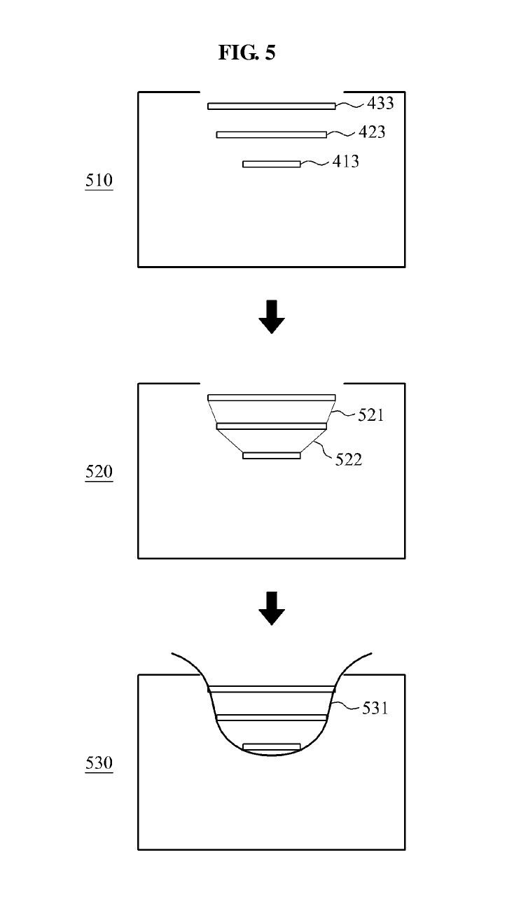

FIG. 5 is a diagram illustrating an example in which an apparatus for measuring a 3D shape reconstructs a 3D shape of an object using extracted section contours according to an embodiment of the present invention.

In operation 510, the 3D shape reconstructor 140 disposes a plurality of section contours extracted by the section contour extractor 130 based on a height. For example, the 3D shape reconstructor 140 disposes the section contour 413 at a very base, and the section contour 423 on top of the section contour 413 as shown in FIG. 5. The 3D shape reconstructor 140 disposes the section contour 433 at a very top of the section contours 413 and 423.

In operation 520, the 3D shape reconstructor 140 connects the section contours 413, 423, and 433 disposed in operation 510. For example, the 3D shape reconstructor 140 connects outside corners of the section contour 413 and the section contour 423 by a line 522 as shown in FIG. 5. The 3D shape reconstructor 140 connects outside corners of the section contour 423 and the section contour 433 by a line 521.

In operation 530, the 3D shape reconstructor 140 reconstructs a 3D shape of an object by performing interpolation on the section contours connected in operation 520. For example, the 3D shape reconstructor 140 reconstructs a 3D shape 531 of an object by performing interpolation on the line 521 and the line 522 in response to a change in the section contours 413, 423, and 433 based on a surface height as shown in FIG. 5.

FIG. 6 is a diagram illustrating a first example of the apparatus 100 for measuring the 3D shape according to an embodiment of the present invention.

FIG. 6 is an example of the apparatus 100 for measuring the 3D shape that generates an image such as the image as shown in Case 2 of FIG. 3.

The lighting 240 in the apparatus 100 for measuring the 3D shape is provided at a side of the main water tank 210 as shown in FIG. 6.

In this example, the lighting 240 outputs a light 610 at an angle so as to be totally reflected on a surface, allowing underneath a surface 620 of a liquid to be brighter than above the surface 620.

An area 601 immersed in a liquid of an object 600 is brighter than an area 602 that receives the light 610 of which a quantity of light is reduced by passing through the surface 620 because the area 601 receives the light 610 output directly from the lighting 240. The surface 620 is brighter above than underneath, and therefore, an image 630 generated by the camera 250 that photographs the object 600 is displayed relatively dark due to darkness above the surface 620.

Accordingly, a boundary between the surface 620 and the object 600 is clearer because the image 630 includes the area 601 displayed to be bright by receiving the light 610, the surface 620 to be displayed dark, and the area 602 as shown in FIG. 6.

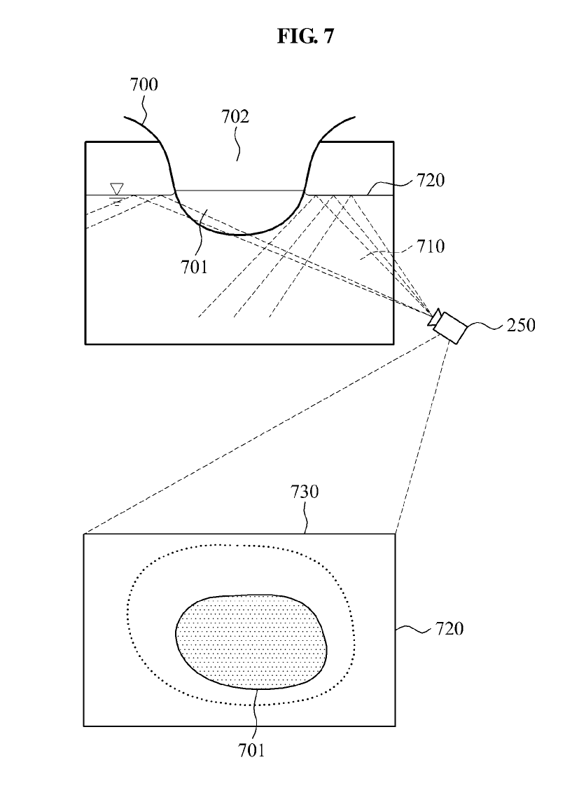

FIG. 7 is a diagram illustrating a second example of the apparatus 100 for measuring the 3D shape according to an embodiment of the present invention.

FIG. 7 is an example of the apparatus 100 for measuring the 3D shape that generates an image such as the image in Case 3 of FIG. 3.

The camera 250 in the apparatus 100 for measuring the 3D shape is provided at a side of the main water tank 210 as shown in FIG. 7. For example, the camera 250 is provided in such a manner that a viewing angle of the camera 250 corresponds to a critical angle of a liquid.

In this example, total reflection occurs on a light 710 reflected off of a surface 720 from among incident lights entering the camera 250, and an area 702 of an object 700 disposed on the surface 720 is not displayed.

Accordingly, a boundary between the surface 720 and the object 700 is clear because an image 730 generated by the camera 250 photographing the object 700 includes the surface 720 displayed to be bright due to the total reflection and an area 701 of the object 700 disposed underneath the surface 720 as shown in FIG. 7.

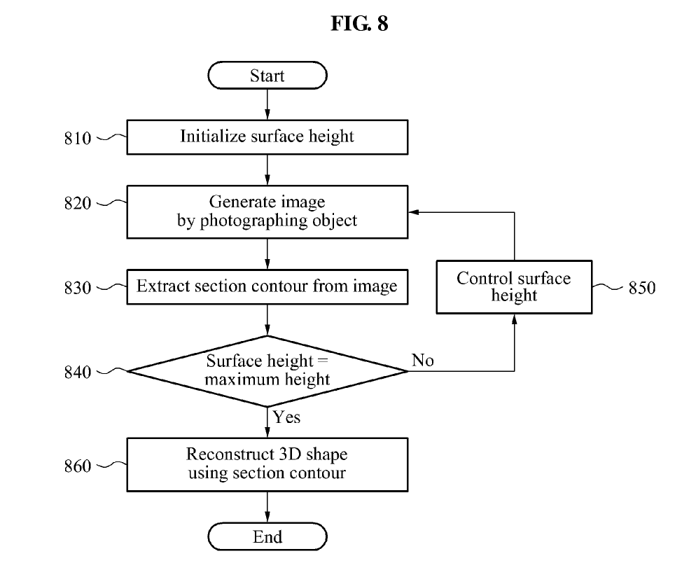

FIG. 8 is a flowchart illustrating a method of measuring a 3D shape according to an embodiment of the present invention.

In operation 810, the controller 110 initializes a surface height by lowering the surface height of a liquid used by the apparatus 101 for generating the tomographic image to a minimum height. In this example, an object of which a 3D shape is to be measured is fixed onto the apparatus 101 for generating the tomographic image. When the object is fixed onto the apparatus 101 for generating the tomographic image, the controller 110 may raise the surface height of the liquid.

In operation 820, the object photographing unit 120 generates an image by photographing the object immersed in the liquid using a camera. For example, when the surface height raised in operation 810 contacts the object and a boundary is formed between the object and a surface of the liquid, the object photographing unit 120 photographs the object immersed in the liquid using the camera.

In this example, the object photographing unit 120 controls intensity of a light source that outputs a light to the liquid, and increases a contrast between an area immersed in the liquid and an area not immersed in the liquid of the object. The object photographing unit 120 photographs the object immersed in the liquid using the camera disposed based on a critical angle of the liquid.

In operation 830, the section contour extractor 130 extracts a section contour that indicates a boundary between the object and the surface of the liquid from the image generated in operation 820.

In operation 840, the controller 110 verifies whether the surface height of the liquid is a maximum height. When the surface height is the maximum height, the controller 110 may perform operation 860 because all section contours of the object are extracted. When the surface height is lower than the maximum height, the controller 110 may perform operation 850.

In operation 850, the controller 110 raises the surface height of the liquid by adding a liquid to a main water tank using a pump. Through iterating operation 830, the section contour extractor 130 extracts the section contours based on a plurality of surface heights by photographing the object immersed in the liquid for the plurality of surface heights of the liquid changed by the controller 110.

In operation 860, the 3D shape reconstructor 140 measures a 3D shape of the object using the section contours extracted in operation 830.

In this example, the 3D shape reconstructor 140 measures the 3D shape of the object by converting pixel coordinates of the section contour to absolute space coordinates. For example, the 3D shape reconstructor 140 converts pixel coordinates, for example, (u, v) of the section contour to absolute space coordinates, for example, (x, y, z). The 3D shape reconstructor 140 reconstructs the 3D shape of the object by performing interpolation on the section contour based on the surface height, and measures the 3D shape of the object using the reconstructed 3D shape.

According to the present exemplary embodiment, it is possible to measure a 3D shape of an object absent an additional optical marking device, such as a laser, by identifying a boundary between a surface naturally created on a liquid and a breast, extracting a section contour from the identified boundary, and reconstructing a 3D shape of an object using the extracted section contour.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of measuring a three-dimensional (3D) shape, the method comprising:
generating an image by photographing an object immersed in a liquid;
extracting, from the image, a section contour indicating a boundary between the object and a surface of the liquid; and
measuring a 3D shape of the object using the extracted section contour.

2. The method of claim 1, wherein the measuring comprises:
measuring the 3D shape of the object by converting pixel coordinates of the section contour to absolute space coordinates.

3. The method of claim 1, further comprising:
changing the boundary by controlling a surface height of the liquid,
wherein the extracting comprises extracting the section contour based on the surface height by photographing the changed boundary.

4. The method of claim 3, wherein the measuring comprises:
reconstructing the 3D shape of the object by performing interpolation on the section contour based on the surface height, and.

5. The method of claim 1, wherein the generating comprises:
increasing a contrast between an area of the object immersed in the liquid and an area not immersed in the liquid by controlling intensity of a light source that outputs a light to the liquid.

6. The method of claim 1, wherein the generating comprises:
photographing the object immersed in the liquid using a camera provided based on a critical angle of the liquid.

7. A method of measuring a three-dimensional (3D) shape, the method comprising:
changing a boundary between an object and a surface of a liquid by controlling a plurality of surface heights of the liquid in which the object is immersed;
extracting a section contour for the plurality of surface heights by photographing the object immersed in the liquid for the plurality of surface heights of the liquid; and
measuring a 3D shape of the object using the section contour for the plurality of surface heights,
wherein the section contour indicates the boundary between the object and the surface of the liquid.

8. The method of claim 7, wherein the measuring comprises:
reconstructing the 3D shape of the object by performing interpolation on the section contour for the plurality of surface heights.

9. The method of claim 7, wherein the extracting comprises:
increasing a contrast between an area of the object immersed in the liquid and an area not immersed in the liquid by controlling intensity of a light source that outputs a light to the liquid.

10. The method of claim 7, wherein the extracting comprises:
photographing the object immersed in the liquid using a camera provided based on a critical angle of the liquid.

11. An apparatus for measuring a three-dimensional (3D) shape, the apparatus comprising:
an object photographing unit to generate an image by photographing an object immersed in a liquid;
a section contour extractor to extract, from the image, a section contour indicating a boundary between the object and a surface of the liquid; and
a 3D shape reconstructor to measure the 3D shape of the object by reconstructing the 3D shape of the object using the extracted section contour.

12. The apparatus of claim 11, wherein the 3D shape reconstructor measures the 3D shape of the object by converting pixel coordinates of the section contour to absolute space coordinates.

13. The apparatus of claim 11, further comprising:
a controller to change the boundary by controlling a surface height of the liquid;
wherein the section contour extractor extracts the section contour based on the surface height by photographing the changed boundary.

14. The apparatus of claim 13, wherein the 3D shape reconstructor reconstructs the 3D shape of the object by performing interpolation on the section contour based on the surface height.

15. The apparatus of claim 11, further comprising:
a controller to increase a contrast between an area of the object immersed in the liquid and an area not immersed in the liquid by controlling intensity of a light source that outputs a light to the liquid.

16. The apparatus of claim 11, wherein the object photographing unit photographs the object immersed in the liquid using a camera provided based on a critical angle of the liquid.

17. An apparatus for measuring a three-dimensional (3D) shape, the apparatus comprising:
a controller to change a boundary between an object and a surface of a liquid in which the object is immersed by controlling a plurality of surface heights of the liquid;
a section contour extractor to extract a section contour for the plurality of surface heights from an image obtained by photographing the object for the plurality of surface heights of the liquid; and
a 3D shape reconstructor to measure a 3D shape of the object by reconstructing the 3D shape of the object using the section contour for the plurality of surface heights,
wherein the section contour indicates the boundary between the object and the surface of the liquid.

18. The apparatus of claim 17, wherein the 3D shape reconstructor reconstructs the 3D shape of the object by performing interpolation on the section contour for the plurality of surface heights.

19. The apparatus of claim 17, wherein the controller increases a contrast between an area of the object immersed in the liquid and an area not immersed in the liquid by controlling intensity of a light source that outputs a light to the liquid.

20. The apparatus of claim 17, wherein the image is generated by photographing the object using a camera provided based on a critical angle of the liquid.
